(19) United States
(12) Patent Application Publication
(10) Pub. No.: US 2003/0041713 A1
(43) Pub. Date: Mar. 6, 2003

(54) Tool

(76) Inventors: Dieter Kress, Aalen (DE); Friedrich Haberle, Lauchheim (DE)

Correspondence Address: MORRISS, BATEMAN, O'BRYANT & COMPAGNI, 136 SOUTH MAIN STREET, SUITE 700, SALT LAKE CITY, UT, 84101, US

(21) Appl. No.: 10/201,167

(22) Filed: Jul. 23, 2002

(30) Foreign Application Priority Data
Jul. 24, 2001 (DE) 10136996.4

(51) Int. Cl. B26D 7/06

(52) U.S. Cl. 83/100; 408/67

(57) ABSTRACT

The invention relates to a tool (1) for machine cutting of workpieces which has a ventilation hood (11) for removing the shavings which arise. The tool is characterized by the fact that the ventilation hood (11) includes a turbine (17).

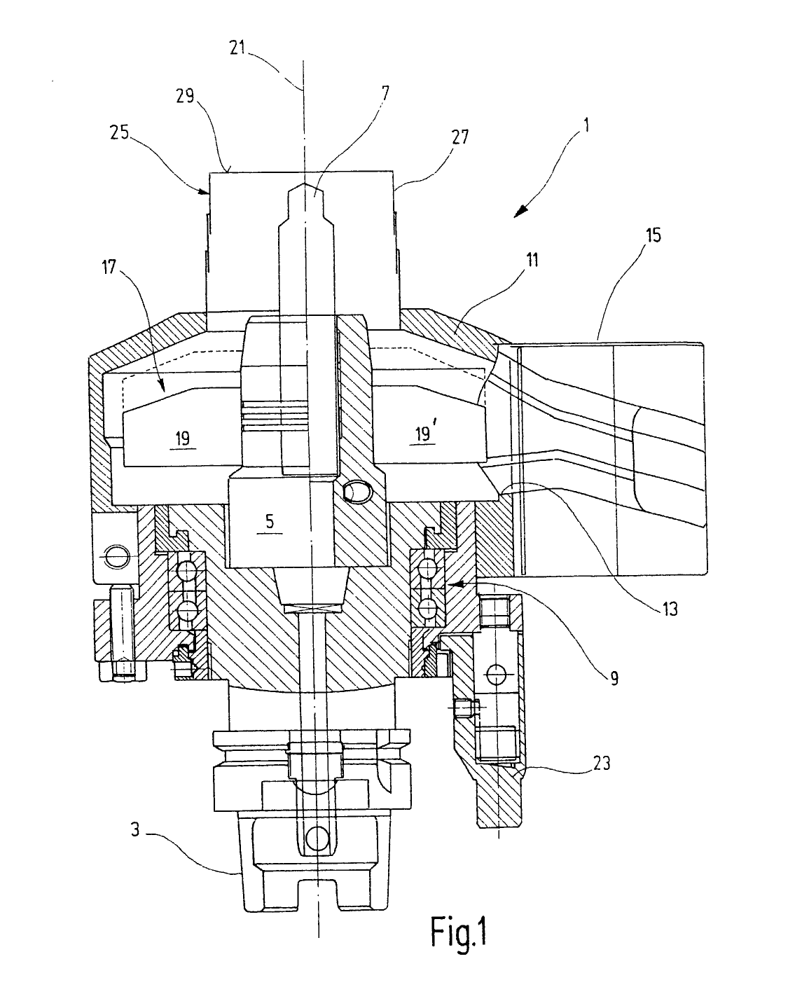

### DESCRIPTION

The invention relates to a tool for machine cutting of workpieces which has a ventilation hood for removing the shavings which arise.

Tools of this type are known in the art. Such tools are used to remove shavings from a workpiece. As a rule, the tool is set in rotation and brought in contact with a stationary workpiece. However, it is also possible to set the workpiece in rotation and bring it in contact with the tool. In so-called wet processing, coolants and lubricants are used and are led to the processing point to cool the tool and also to lubricate the processing point. In addition, the shavings arising during cutting are carried away from the processing area by the coolant and the lubricant. The removal of generated shavings from the cutting site is often problematic with dry and minimal lubrication, since no liquid coolant or lubricant is used in this type of processing. The cutting site is instead cooled by supplied air, and the shavings which arise are removed by the air stream. Thus, it is possible for small quantities of a lubricant to be added to the air. Ventilation hoods have already been used having a suction motor. This suction unit subjects the ventilation hood to a partial vacuum which is used to remove the shavings which arise during cutting. It has turned out that tools of this design are very large and thus not amenable to general use. In addition, automatic tool changing is possible only with great difficulty. Furthermore, tools of this design are costly.

The object of the invention is to provide a tool of the aforementioned type which does not have this disadvantage. This object is achieved by providing a tool comprising the features stated in Claim 1. The tool is characterized by the fact that a turbine with which a partial vacuum can be created is housed in the ventilation hood used for removal of the shavings arising during cutting. This partial vacuum serves to remove the shavings which are generated. The ventilation hood has a very compact design and can therefore be used in many different situations. In addition, it is possible to automatically change tools having such a ventilation hood because a connection to external suction devices can be omitted.

A tool is preferred which is characterized by the fact that the turbine is driven by the tool itself. In this manner, the space requirements can be minimized because a separate turbine drive within the ventilation hood can be omitted. Further embodiments result from the other subclaims.

The invention is described in more detail hereinafter with reference to the drawing, which comprises a single FIGURE. The FIGURE shows a tool in partial longitudinal section.

The tool 1 illustrated in the FIGURE comprises a shank 3 by which tool 1 may be coupled to a machine tool. To shank 3 a tool holder 5 is non-rotatably coupled which accommodates a tool 7, which is only implied here. A ventilation hood 11 is connected to tool 1 via a suitable bearing unit 9, and is used to take up shavings removed from the tool which are then ejected via a discharge opening 13 in the housing of ventilation hood 11. The shavings may be ejected directly into a shavings conveyor or carried away via an extension 15.

In the interior of ventilation hood 11 a turbine 17 is situated which has at least one, preferably a plurality of equidistantly arranged turbine blades which in the following description are referred to as blades 19, 19′ for brevity. The outer contour of blades 19, 19′ is adapted to the inner shape or inner contour of ventilation hood 11 to ensure maximum air intake.

Blades 19, 19′ here are mounted directly to tool holder 5 in such a way that they may be set in rotation by the machine tool via shank 3.

Thus, an additional drive for turbine 17 is not necessary in order to create a partial vacuum inside ventilation hood 11 for drawing in the shavings removed from tool insert 7.

Tool 1 has a very small design because turbine 17 is a part of tool 1, in particular a part of tool holder 5.

The shape of blades 19, 19′ may be varied. Thus, it is not absolutely necessary that the blades lie in the planes containing rotational axis 21 of tool 1, nor that they run radially thereto. The blades may also be arranged at an angle to an imaginary diametric line, or they may have a curved design and/or a special configuration in particular on their front face—as seen in the direction of rotation—in order to optimally pick up the shavings arising during cutting and eject them from discharge opening 13.

Here, turbine 17 has individual blades 19, 19′ connected to tool holder 5. It is also possible to attach to tool holder 5 a turbine ring from which the blades originate.

In order to avoid rotation of ventilation hood 11 during operation of tool 1, a torque arm 23 is provided by which ventilation hood 11 is supported on and non-rotationally mounted to the machine tool, not illustrated here. Ventilation hood 11 preferably has a variable-length intake section 25 which encloses tool insert 7. Variable-length intake sections are known in the art. The design here is preferably implemented by inserting a spring band spiral 27 whose windings as seen in the longitudinal direction, and thus in the direction of rotational axis 21, may be telescopically pushed one inside the other. In general, other designs may also be used, such as intake sections constructed as a telescoping bellows. Thus, it is possible for a front face 29 of intake section 25 to rest on the workpiece to be processed or to be situated in the immediate vicinity thereof. Optionally, protective devices made of plastic or a similar material may be provided on front face 29 so that damage to the workpiece surface and wear on front face 29 are avoided.

Ventilation hood 11 is arranged on tool 7 in such a way that tool 7 can be displaced in the direction of its rotational axis 21 during processing of a workpiece. Tool 7 may thus be designed as a bore, fine bore, reamer, or as a router or core drill tool. Since ventilation hood 11 is variable in length, it may project above the tool in the axial direction in the starting position, and thus when tool 7 is not being used, so that the tool does not project above front face 29 of ventilation hood 11, thus providing some measure of protection for the front face. Particular care should be taken, however, that during processing of the workpiece ventilation hood 11 is resting on the surface of the workpiece before the first shavings are removed from tool 7. This ensures that no shavings can escape from the processing area, even at the start of processing. While tool 7 is being inserted into the workpiece in the direction of rotational axis 21, ventilation hood 11 becomes shortened because its wall is designed as a spring band spiral 27, for example, whose windings can telescope one inside the other as seen from the longitudinal direction.

Ventilation hood 11 is preferably arranged concentrically with tool 7, as shown in the FIGURE. The inner diameter of ventilation hood 11 may be considerably larger than the outer diameter of tool 7 because front face 29 of intake section 25 rests on the workpiece to be processed and forms somewhat of a sealed suction space from which the removed shavings cannot exit. The inner diameter of intake section 25 is preferably 1.5 to 5.0 times larger than the outer diameter of tool 7. In particular, the inner diameter is approximately 4.0 to 4.8 times larger. An inner diameter of intake section 25 that is approximately 4.5 times larger is particularly preferred.

Since intake section 25 can also be arranged at a great distance from tool 7, it is possible to combine various tools with one ventilation hood 11. Ventilation hood 11 thus has universal application.

Because intake section 25 is variable in length, it may likewise be matched to many different tools 7. In particular, it is possible to use ventilation hood 11 somewhat as a protective hood, since front face 29 of intake section 25 preferably rises above the front end of tool 7.

Above all, it is particularly advantageous that intake section 25 of ventilation hood 11 can be designed in such a way that the intake section contacts the surface of the workpiece before the first shavings are removed, and can be telescoped elastically in the direction of the axis of the tool or rotational axis 21, and thus opposite to the direction of feed for tool 7. Because of the great distance between intake section 25 and tool 7, shavings having the shape of a long spiral may also be reliably carried away from the processing area, which also contributes to the universal applicability of ventilation hood 11 for many different processing objectives.

Turbine 17 is used to generate a partial vacuum inside ventilation hood 11 which can be influenced by the design of blades 19, 19′, and therefore by the outer contour of blades 19, 19′ which is adapted to the interior of ventilation hood 11, the blades being dimensioned, for example, as indicated by a dashed line in the FIGURE. It is also possible, however, to enlarge the contour via its design, by constructing it with a flat or arched shape.

The partial vacuum in ventilation hood 11 is preferably led via variable-length intake section 25 directly to the cutting site, so that all shavings which arise are taken up. Front face 29 of intake section 25 may rest flat on the workpiece. It is also possible to provide recesses here in order to take in more air which is then used for the removal of shavings which arise. However, it is also conceivable to introduce recesses in the outer wall of intake section 25, such as by providing holes in spring band spiral 27, for example, to achieve the desired suction effect.

In particular, when ventilation hood 11 has no extensions on its exterior, and thus when extension 15 is omitted, tool 1 may be easily replaced and used in automatic machining centers.

Since the intake capacity of turbine 17 depends on the revolutions per minute of tool 1, the shaping of blades 19, 19′ may be used to affect the output of turbine 17 in order to ensure the desired suction capacity.

In summary, it has been shown that tool 1 has a simple design and can be readily combined with existing machine tools. In addition, it is possible in a simple manner, in particular with the use of a turbine ring, to house different types of turbines 17 in ventilation hood 11 and to achieve the desired suction capacity.

In addition, in order to carry away shavings a discharge duct may be readily attached to extension 15 from which the shavings which are drawn in by turbine 17 are ejected.

Tool 1 described here can be used in particular with dry and/or minimal lubrication. In general, this use is also possible for wet processing.

Any suitable material may be used in the fabrication of turbine 17, such as aluminum or a suitable synthetic material.

Tool 1 is characterized by a very simple, compact design. It is therefore hardly susceptible to malfunction. It is also very light since turbine 17 is driven directly by the tool—by tool holder 5 of tool 1, for example—so that provision of an additional drive inside ventilation hood 11, or even an external drive, is unnecessary.

Since it is possible to combine turbine 17 with many different types of tool holders 5, reamers and bores as well as milling cutters may be introduced in tool holder 5. Tool 1 is also very amenable to variation.

1. Tool for machine cutting of workpieces which has a ventilation hood for suction removal of the shavings which arise, characterized in that the ventilation hood (11) includes a turbine (17).

2. Tool according to claim 1, characterized in that the turbine (17) is driven by the tool (1).

3. Tool according to claim 1 or 2, characterized in that the turbine (17) is a part of the tool (1), in particular a part of a tool holder (5) for the tool (1).

4. Tool according to one of the preceding claims, characterized in that the turbine (17) has at least one blade (19, 19′).

5. Tool according to one of the preceding claims, characterized in that it is possible to adapt the shape of at least one blade (19, 19′) to the inner contour of the housing of the ventilation hood (11).

6. Tool according to one of the preceding claims, characterized in that it is possible to adapt the angular position of at least one blade (19, 19′) and/or its design to various intake situations.

7. Tool according to one of the preceding claims, characterized in that the ventilation hood (11) is attached to the tool (1).

8. Tool according to one of the preceding claims, characterized in that the ventilation hood (11) has a torque arm (23).

9. Tool according to one of the preceding claims, characterized in that the ventilation hood (11) has a variable-length intake section (25).

10. Tool according to one of the preceding claims, characterized in that the length of the intake section (25) may be varied in the direction of the rotational axis (21).

11. Tool according to one of the preceding claims, characterized in that the intake section (25) has a front face (29) which projects over the tool (7).

12. Tool according to one of the preceding claims, characterized in that the intake section (25) has an inner diameter which is significantly—preferably approximately 1.5 to 5.0 times, in particular approximately 4.0 to 3.8 [sic; 4.8] times—greater than the outer diameter of the tool (7).
